(19) United States
(12) Patent Application Publication
(10) Pub. No.: US 2024/0124291 A1
(43) Pub. Date: Apr. 18, 2024

(54) WINE STORAGE DEVICE AND WINE EXTRACTION METHOD USING SAME

(71) Applicant: LG ELECTRONICS INC., Seoul (KR)

(72) Inventors: Ja Yoen KIM, Seoul (KR); Kichu HONG, Seoul (KR); Hwayun CHOI, Seoul (KR)

(21) Appl. No.: 18/268,014

(22) PCT Filed: Dec. 13, 2021
(86) PCT No.: PCT/KR2021/018894

§ 371 Date: Jun. 16, 2023

(30) Foreign Application Priority Data
Dec. 16, 2020 (KR) 10-2020-0176567

(51) Int. Cl. B67D 1/08; B67D 1/00

(52) U.S. Cl. CPC B67D 1/0884; B67D 1/0081; B67D 2001/0091

(57) ABSTRACT

Proposed are a wine storage device and a wine dispensing method using the same. In the wine storage device, a storage space (32) for storing a wine bottle (B) is formed inside a cabinet (10), and a vision sensor part (50) can be arranged in the cabinet (10). In addition, a main control part (150) can extract information of wine from an image of a wine label (B1) captured by the vision sensor part (50). The wine contained in the wine bottle (B) can be dispensed through an dispensing head (100) to the outside. An aerating part (A) is provided in the dispensing head (100) and a discharge hole (143) for discharging the wine to a contact space (113) can be formed in the aerating part (A).

### TECHNICAL FIELD

The present disclosure relates to a wine storage device, and more particularly, to a storage device for storing a wine bottle and a method for dispensing wine from the wine bottle stored in the storage device.

### BACKGROUND ART

Generally, a refrigerator is a home appliance that allows low-temperature storage of food in an inner storage space shielded by a door. To this end, the refrigerator is configured to cool the inside of the storage space by using cool air generated through heat exchange with a refrigerant circulating in a refrigerating cycle so that food can be stored in an optimal state.

Recently, a refrigerator is gradually becoming multi-functional in accordance with changes in dietary life and the trend of high-end products, and a refrigerator equipped with various structures and convenience devices that enable a user's convenience and efficient use of internal space is being released. In particular, as the consumption and preference of alcoholic beverages such as wine and champagne increase, a refrigerator exclusively for wine is being used to store wine.

In the case of wine, it is necessary to set the appropriate temperature value of wine according to the type of wine. That is, a user can adjust the temperature of a beverage according to the nature of the beverage or his/her taste.

Particularly, according to the inlet of contact of wine with air, flavors of wine can soften and aromas of wine can be intensified. For this purpose, recently, a wine aerator is used. The wine aerator is coupled to the mouth of a wine bottle to increase the inlet of contact of dispensed wine with air.

U.S. Pat. No. 6,568,660B1 (prior art 1) discloses a wine aerator which is coupled to the inlet of a wine bottle so that air can be injected into the wine bottle, and U.S. Pat. No. 9,676,508B2 (prior art 2) discloses a technique in which a wine aerator is coupled to the inlet of the wine bottle to increase the amount of contact of dispensed wine with air. However, these conventional wine aerators have a limitation in that an aerating intensity cannot be adjusted according to the type of wine or the taste of a user.

U.S. Pat. No. 10,160,630 B1 (prior art 3) discloses a technology in which a beverage can be automatically dispensed by using a pump and the degree of aerating can be adjusted. However, in prior art 3, a wine aerator has a pump mounted therein and thus makes a lot of noise, and a user has to manually adjust the degree of aerating, which is inconvenient.

In addition, since each of the conventional wine aerators is separated from the inlet of the wine bottle after pouring wine or coupled to the wine bottle and functions as only the lid of the wine bottle, and accordingly, wine remaining in the wine bottle is continuously oxidized and the taste of the wine is deteriorated.

### DISCLOSURE

### Technical Problem

The present disclosure has been made to solve the above problems occurring in the prior art, and is intended to propose a wine storage device which can appropriately aerate wine after automatically recognizing characteristics of the wine such as the type of wine.

Another objective of the present disclosure is to enable an aerating intensity of wine to be adjusted according to the storage condition of the wine.

Still another objective of the present disclosure is to ensure that wine left in an open wine bottle does not oxidize during storage.

### Technical Solution

According to the characteristics of the present disclosure in order to accomplish the above objectives, a storage space in which a wine bottle is stored may be defined inside a cabinet, and a vision sensor part may be disposed in the cabinet. In addition, a main control part may extract wine information from an image of a label of wine captured by the vision sensor part. The wine contained in the wine bottle may be dispensed through a dispensing head to the outside. The dispensing head may include an aerating part, wherein the aerating part may have a discharge hole through which wine is discharged to a contact space. In the aerating part, as a driving part is operated by the main control part, at least one of the size, length, number, or direction of the discharge hole may be adjusted. Accordingly, the wine storage device of the present disclosure may obtain information such as the type of wine by automatically recognizing the label of the wine, and may adjust an aerating intensity of the wine to be dispensed based on the obtained information.

In addition, the cabinet may include a door that opens and closes the storage space, and the vision sensor part may be disposed on the door. Accordingly, the angle of view of the vision sensor part may be adjusted by adjusting the degree of opening and closing of the door.

The vision sensor part may be disposed on an inner surface of the door facing the storage space. Through this structure, the vision sensor part may be prevented from being exposed to the outside.

In addition, when the main control part extracts information of the label from the vision sensor part, a display device may display whether information is extracted. Accordingly, a user may check whether the wine information has been acquired.

In addition, a database may be connected to the main control part, and the wine information may be stored in the database. The main control part may operate the driving part by comparing information extracted by the vision sensor part with information stored in the database. Accordingly, a user may drink the most appropriately aerated wine.

Furthermore, the cabinet may be provided with an input part, and the main control part may operate an actuator with information manually input through the input part. That is, a user may manually adjust the aerating intensity.

In addition, when the aerating part is deactivated, the wine may be dispensed through only a main dispensing pipe of the dispensing head. When the aerating part is activated, the wine may be dispensed through the discharge hole together with the main dispensing pipe or through only the discharge hole. Likewise, the aerating intensity may be easily adjusted through the main dispensing pipe and the discharge hole.

In this case, the aerating part may include an opening and closing body moving up and down in the contact space and a discharge body having the discharge hole. The discharge body may be received inside the opening and closing body, and may have the discharge hole including at least one discharge hole. In addition, the driving part may be connected to the opening and closing body to move the opening and closing body up and down. When the opening and closing body is raised or lowered by the driving part, at least a portion of the discharge holes may be opened and wine may be discharged through the discharge hole.

Additionally, the aerating part may be provided with the main dispensing pipe connected to the wine bottle, and the opening and closing body may move up and down along the main dispensing pipe. That is, the main dispensing pipe may also serve to guide the raising and lowering of the opening and closing body.

In addition, the discharge hole may include multiple discharge holes formed in an outer circumferential surface of the discharge body along the outer circumferential surface, or may include multiple discharge holes formed at different heights of the discharge body.

Meanwhile, in the aerating part, a rotary dispensing pipe may be rotatably provided inside the contact space. The discharge hole may be formed inside the rotary dispensing pipe in a longitudinal direction thereof, and the driving part may rotate the rotary dispensing pipe. In this case, when the rotary dispensing pipe is in a first state in which the rotary dispensing pipe is erected, the discharge hole may be open toward a wine discharge hole of the dispensing head, and when the rotary dispensing pipe is rotated in a second state, the discharge hole may not correspond to the wine discharge hole and may open toward an inner surface of the contact space. Likewise, the aerating intensity may be adjusted by rotating the rotary dispensing pipe.

In addition, the contact space may have a disk shape or a spherical shape, and since entire length of the rotary dispensing pipe is shorter than an inner diameter of the contact space, opposite ends of the rotary dispensing pipe may be spaced apart from the inner surface of the contact space.

Additionally, an inlet of the rotary dispensing pipe connected to the wine bottle may have a larger inner diameter than an outlet of the rotary dispensing pipe through which the wine is discharged. In this case, the wine may be discharged more efficiently through the inlet of the rotary dispensing pipe.

In addition, the aerating part may include a first dispensing pipe fixed to the contact space and a second dispensing pipe connected to the first dispensing pipe. The second dispensing pipe may overlap the first dispensing pipe or may extend in a direction away from the first dispensing pipe, and the driving part may operate the second dispensing pipe. The aerating intensity may be adjusted by adjusting the overall length of the first dispensing pipe and the second dispensing pipe.

Additionally, the cabinet may be provided with a communication module, and the communication module may transmit information of the database to an external server and receive information from the external server. Accordingly, the information of the wine may be updated, and analysis of the wine information may be entrusted to the external server.

In addition, the communication module may be wirelessly connected to a user terminal. The communication module may transmit information of the database to the user terminal, or information received from the user terminal may be stored in the database.

Additionally, a spectral sensor part may be disposed in the cabinet. The spectral sensor part may measure spectral light from the wine and provide information of the wine to the main control part. Likewise, the wine storage device of the present disclosure may include the spectral sensor part which checks the current state of the wine. That is, in addition to fixed conditions such as the type of wine, variable conditions such as current sugar content and acidity of the wine may be checked, and accordingly, the wine may be aerated more accurately.

In addition, the spectral sensor part may be disposed in a path of a dispensing pipe through which wine contained in the wine bottle is dispensed, or may be disposed in a measuring tank in which a portion of the wine is temporarily stored. Accordingly, the spectral sensor part may analyze wine in a non-contact way.

In this case, the database may store information of a name, a type, a production area, and a production year of the wine extracted from the vision sensor part, and at least one piece of information of a sugar content, a pH (hydrogen ion concentration), alcohol concentration, and tannin concentration of the wine transmitted from the spectral sensor part.

In addition, a gas tank may be disposed in the cabinet to prevent oxidation of the wine by delivering an inert gas to the inside of the wine bottle. The gas tank may prevent the wine from being oxidized in contact with air during storage of the wine

Additionally, inside the cabinet, a cooling device may be installed at rear of the storage space and may be controlled by the main control part. The cooling device may keep the wine at an appropriate temperature.

In addition, a support part on which a bottom surface of the wine bottle is seated may be disposed on a bottom of the storage space, and the support part may adjust height of the label while being raised or lowered or may adjust an angle at which the label is directed while rotating.

A method of dispensing wine according to the present disclosure may include obtaining the image of the label of the wine bottle photographed through the vision sensor part disposed in the cabinet of the wine storage device. In addition, extracting characters or symbols included in the image of the label by the main control part may follow. The extracted characters or symbols may be compared with information stored in the database to obtain the wine information.

In addition, supplying the wine contained in the wine bottle to the dispensing head by a supply means provided in the wine storage device may follow. In this case, the method may further include aerating the wine dispensed by the aerating part disposed in the dispensing head and adjusting the aerating intensity according to the wine information obtained by the main control part may be further included.

### Advantageous Effects

As described above, the wine storage device and the wine dispensing method using the same according to the present disclosure have the following effects.

The wine storage device of the present disclosure can automatically recognize the label of wine, obtain information such as the type of the wine, and aerate the wine to be dispensed based on the obtained information. Accordingly, a user is not required to check the type of each wine and adjust aerating intensity thereof accordingly, thereby aerating wine more easily.

Particularly, in the present disclosure, the aerating part may be controlled by the main control part to automatically adjust the aerating intensity. Accordingly, the wine storage device may automatically implement the most appropriate aerating according to the type of wine to provide the wine to a user, thereby increasing usability.

In addition, in the present disclosure, the spectral sensor part may be provided to check the current state of wine. In addition to the fixed conditions such as the type of wine, the variable conditions such as current sugar content and acidity of wine can be checked, thereby enabling more accurate aerating of wine. Accordingly, a user can drink wine with the most appropriate flavor at the point of drinking.

Additionally, in the present disclosure, the information of a label of the wine can be acquired through the vision sensor part. When a situation in which the information of the label cannot be acquired occurs, the wine storage device can inform this to a user. In response to this, a user can adjust the angle of view of the vision sensor part. When the vision sensor part is installed on the door, the angle of view can be adjusted very easily. Accordingly, according to the present disclosure, usability of the wine storage device is improved.

In addition, the wine storage device of the present disclosure may automatically adjust the aerating intensity, but the aerating intensity may be adjusted through manual input by the user. In this case, a value manually input by the user may be stored in the database, and an aerating value suitable for the user's usage pattern or the type of wine may be learned, thereby enabling more precise and accurate aerating.

Additionally, the wine storage device of the present disclosure may supply an inert gas to the inside of an opened wine bottle, preventing oxidation of wine. Accordingly, even if the wine is stored in an open state, the taste of the wine may be prevented from deteriorating through oxidation.

In addition, the wine storage device of the present disclosure may include the cooling device to cool the wine bottle. In this case, the cooling device may provide the most appropriate storage temperature according to the type and current state of wine, thereby improving the storage quality of wine.

### DESCRIPTION OF DRAWINGS

FIG. 1 is a perspective view illustrating the configuration of a wine storage device according to an embodiment of the present disclosure.

FIG. 2 is the configuration of the wine storage device of FIG. 1 shown at a different angle from an angle at which the wine storage device is illustrated in FIG. 1.

FIG. 3 is a cross-sectional view taken along line I-I′ of FIG. 1.

FIG. 4 is a cross-sectional view illustrating a state in which a support part in FIG. 3 is lowered.

FIG. 5 is a perspective view illustrating a state in which a door constituting the wine storage device of the present disclosure according to the embodiment is opened at a first angle.

FIG. 6 is a perspective view illustrating a state in which the door constituting the wine storage device of the present disclosure according to the embodiment is opened at a second angle.

FIG. 7 is a perspective view illustrating a state in which the door constituting the wine storage device of the present disclosure is closed according to the embodiment.

FIG. 8 is a structural schematic diagram illustrating the internal structure of the wine storage device according to the present disclosure.

FIG. 9 is a view schematically illustrating the structure of a spectral sensor part constituting the wine storage device according to the present disclosure.

FIG. 10 is a perspective view illustrating the structures of an air pump and a gas tank installed inside the wine storage device according to the present disclosure.

FIG. 11 is a cross-sectional view illustrating a first embodiment of an aerating part constituting the wine storage device according to the present disclosure.

FIG. 12 (a) to (c) are cross-sectional views illustrating a process in which the aerating part of FIG. 8 operates.

FIG. 13 is a cross-sectional view illustrating a second embodiment of the aerating part constituting the wine storage device according to the present disclosure.

FIGS. 14 (a) and (b) respectively are cross-sectional views illustrating processes in which the aerating part of FIG. 10 operates.

FIG. 15 is a cross-sectional view illustrating a third embodiment of the aerating part constituting the wine storage device according to the present disclosure.

FIGS. 16 (a) and (b) respectively are cross-sectional views illustrating processes in which the aerating part of FIG. 12 operates.

FIG. 17 is a cross-sectional view illustrating a fourth embodiment of the aerating part constituting the wine storage device according to the present disclosure.

FIGS. 18 (a) and (b) respectively are cross-sectional views illustrating processes in which the aerating part of FIG. 14 operates.

FIG. 19 is a cross-sectional view illustrating a fifth embodiment of the aerating part constituting the wine storage device according to the present disclosure.

FIG. 20 (a) to (c) are respectively cross-sectional views illustrating processes in which the aerating part of FIG. 16 operates.

FIG. 21 is a perspective view illustrating another embodiment of the wine storage device according to the present disclosure.

FIG. 22 is a view illustrating connection structure between each component based on a main control part of the wine storage device according to the present disclosure.

FIG. 23 is a flowchart illustrating the step of setting an aerating intensity by using the wine storage device according to the present disclosure.

FIG. 24 is a flowchart sequentially illustrating the process of dispensing wine by using the wine storage device according to the present disclosure.

FIG. 25 is a flowchart sequentially illustrating the process of adjusting an aerating value by using the spectral sensor part of the wine storage device according to the present disclosure.

FIG. 26 is a relationship diagram illustrating an information flow between the wine storage device according to the present disclosure and an external server.

### MODE FOR INVENTION

Hereinbelow, some embodiments of the present disclosure will be described in detail with reference to the accompanying drawings. It should be noted that in adding reference numerals to the components of each drawing, the same components have the same reference numerals as possible even though they are displayed on different drawings. In addition in describing the embodiments of the present disclosure, when it is determined that detailed descriptions of related well-known structures or functions hinder understanding of the embodiments of the present disclosure, detailed descriptions thereof will be omitted.

Additionally, in describing the components of the embodiments of the present disclosure, terms such as first, second, A, B, (a), and (b) may be used. These terms are only for distinguishing the components from other components, and the nature or order of the components is not limited by the terms. When a component is described as being “connected” or “coupled” to another component, the component may be directly connected to or coupled to the another component, but it should be understood that still another component may be “connected” or “coupled” thereto between each component.

The embodiment of a wine storage device of the present disclosure will be described with reference to the accompanying drawings. The wine storage device of the present disclosure may dispense wine contained in a wine bottle B while storing the wine bottle B with a lid open. The wine storage device may adjust the storage temperature of the wine and may aerate the wine being dispensed. Hereinafter, a structure related to the function of the wine storage device will be mainly described in detail.

For reference, the aerating of wine means contacting of wine with air in order to enhance the flavor of wine and intensify the aroma of wine. In general, wine is aerated while a user directly turns a wine glass, but in the present disclosure, such aerating may be performed automatically.

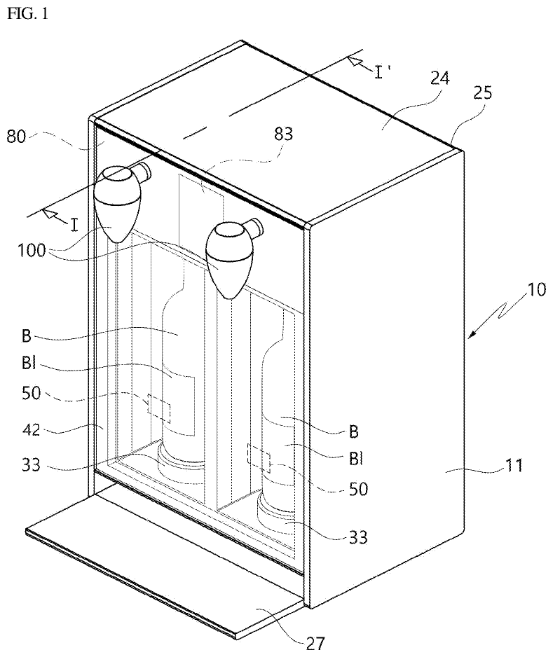

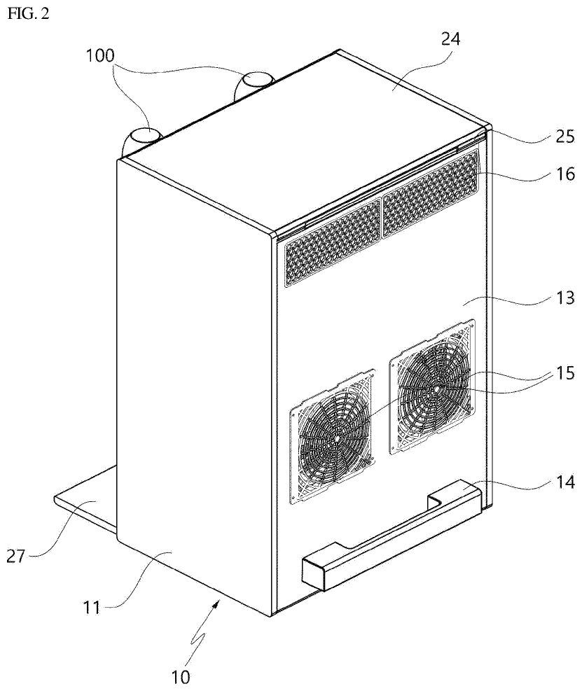

Referring to FIGS. 1 and 2, a cabinet 10 may constitute the exterior of a refrigerator. As illustrated in the drawings, the cabinet 10 may be made to have a relatively short front-to-rear width. Accordingly, in the present embodiment, the refrigerator has a small bottom area and thus may not require a large installation area, so the refrigerator may be placed on the floor or installed on a table.

In the present embodiment, the cabinet 10 may have an approximately hexahedral shape and may have an installation space S inside the cabinet 10. An inner casing 30 and a cooling device C to be described below may be installed in the installation space S. Furthermore, a storage space 32 may be defined inside the inner casing 30 so that the wine bottle B can be received in the storage space 32.

The installation space S may mean the entire inner space of the cabinet 10, and the storage space 32 may be a space defined inside the inner casing 30. Accordingly, it may be considered that the storage space 32 is defined inside the installation space S. The storage space 32 may be a space in which the wine bottle B is stored and may be a space created by combining multiple parts including a cooling guide 40 to be described below.

The cabinet 10 may include one pair of side plates 11, a rear plate 13, an upper cover 20, and a lower cover 26. The one pair of side plates 11, the rear plate 13, the upper cover 20, and the lower cover 26 may be assembled together to define the installation space S inside and constitute the exterior of the refrigerator. The door 42 to be described below may be installed on the front surface of the cabinet 10, and this will be described again below.

Looking at the rear plate 13 constituting the cabinet 10, the rear plate 13 may include an air introduction hole and an air discharge hole. The air introduction hole may be a part through which external air is introduced, and the air discharge hole may be a part through which internal air of the refrigerator is discharged to the outside. In the present embodiment, the air introduction hole may be formed in an introduction grille 15 assembled to the rear plate 13, and the air discharge hole may be formed in a discharge grille 16 assembled to the rear plate 13. Of course, the introduction grille 15 and the discharge grille 16 may be omitted, and the air introduction hole and the air discharge hole may be directly formed in the rear plate 13.

The rear plate 13 may have a spacer 14. The spacer 14 may protrude outward from the rear plate 13, that is, toward a side opposite to the installation space S of the refrigerator. The spacer 14 may be intended to keep a distance between the rear plate 13 and the wall surface of an installation place in which the refrigerator is installed, and is made long in the left and right directions as shown in FIG. 2. The spacer 14 may naturally form an air flow space between the rear plate 13 and the wall surface of the installation place. Such a spacer 14 may also function as a kind of handle. That is, a user may hold the spacer 14 and move the refrigerator.

The upper cover 20 may be assembled on the upper sides of the one pair of side plates 11 and the rear plate 13, and may constitute the upper surface of the installation space S. In the present embodiment, the upper cover 20 may cover the upper side of the cabinet 10, but may have an open structure in some cases. For example, a hinge 25 may be connected to the upper cover 20, and the upper cover 20 may open the installation space S while rotating around the hinge 25. Reference numeral 24, which is not described, denotes an outer cover covering the upper cover 20.

The lower cover 26 may be located on the bottom side of the cabinet 10 corresponding to the opposite side of the upper cover 20. The lower cover 26 may constitute the lower surface of the cabinet 10 and have a flat plate structure. Since the lower cover 26 provides a surface on which the refrigerator is installed, it is preferable that the bottom surface of the lower cover 26 is formed as a flat surface.

The lower cover 26 may have a support plate 27. The support plate 27 may be a part protruding forward from the lower cover 26 and may be regarded as a part of the support plate 27. The support plate 27 may be provided at a position facing a dispensing head 100 to be described below. Accordingly, when a beverage is dispensed through the dispensing head 100 while a cup is placed on the support plate 27, the cup may be filled with the beverage.

The inner casing 30 may be installed inside the cabinet 10. The inner casing 30 may be installed in the installation space S of the cabinet 10 and may be installed by being surrounded by the cabinet 10. The storage space 32 may be formed inside the inner casing 30, and the wine bottle B may be stored in the storage space 32. The storage space 32 of the inner casing 30 may include multiple storage spaces.

The inner casing 30 may have a three-dimensional structure surrounding the storage space 32 based on the storage space 32 at the center of the inner casing. In the present embodiment, the inner casing 30 may be seen as an approximate hexahedral shape, but is not necessarily limited thereto. The inner casing 30 may be made entirely or at least partially of a non-metallic material. In the present embodiment, in the inner casing 30, a receiving guide 35 at the upper side thereof may be made of a non-metallic material, and the cooling guide 40 at the lower side thereof may be made of a metallic material.

A support part 33 may be arranged on a bottom part 31b. The support part 33 may protrude from the bottom part 31b in a direction toward the storage space 32 and have an approximately cylindrical shape. The support part 33 may be a part that supports the lower surface of the wine bottle B. The support part 33 preferably has an area equal to or greater than the lower surface of the wine bottle B.

The support part 33 may include an up-and-down moving body (reference numeral not given) and an actuator 33a. The up-and-down moving body may be installed on the bottom part 31b in a form of being capable of moving up and down. That is, the up-and-down moving body may protrude upward from the bottom part 31b or may be retracted in the opposite direction.

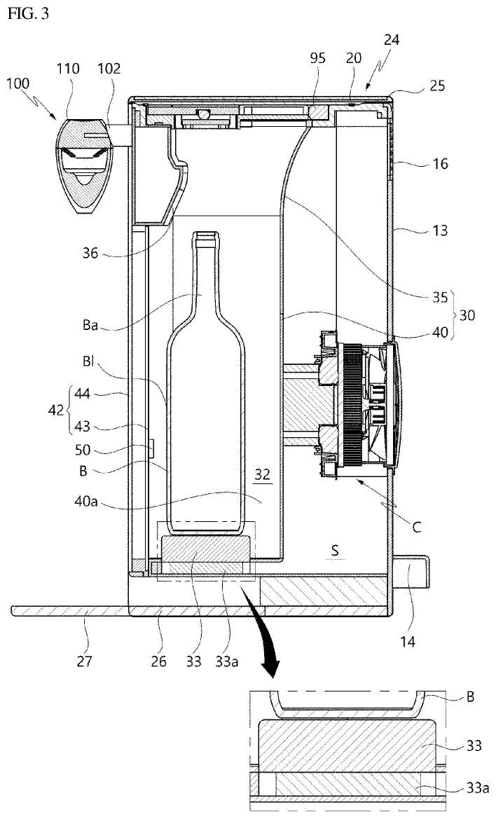

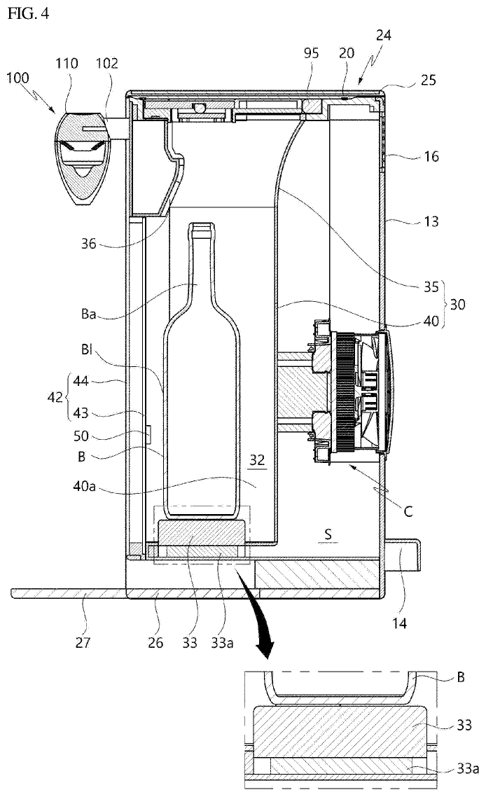

Accordingly, since the up-and-down moving body has a structure capable of moving up and down, wine bottles B of various heights may be accommodated in the storage space 32. That is, when a wine bottle B having a high height is received in the storage space, the up-and-down moving body may descend to further secure the height of the storage space 32 (see FIG. 3), and when a wine bottle B having a low height is received in the storage space, the up-and-down moving body may move upward to fill the remaining space (see FIG. 4).

To this end, the actuator 33a may raise and lower the up-and-down moving body. That is, the actuator 33a may be connected to a support part driving source 34 such as a motor or hydraulic cylinder and may raise and lower the up-and-down moving body while being moved up or down by the support part driving source 34.

In this case, as will be described below, when the up-and-down moving body moves up and down, a vision sensor part 50 may provide an angle of view suitable for photographing the label B1 of the wine bottle B. The vision sensor part 50 may obtain wine information by photographing the label B1, and the most appropriate angle of view may be preset while the up-and-down moving body moves up and down.

Meanwhile, the entirety of the support part 33 or the up-and-down moving body thereof may be rotated. Although not shown, a motor which is the support part driving source 34 may be mounted on the lower part of the support part 33 so that the entirety of the support part 33 or the up-and-down moving body can be rotated. When entirety of the support part 33 or the up-and-down moving body rotates, an appropriate angle of view for the vision sensor part 50 to photograph the label B1 of the wine bottle B may be preset. The vision sensor part 50 may obtain information of wine by photographing the label B1, and the most appropriate angle of view may be preset while the entirety of the support part 33 or the up-and-down moving body rotates.

The raising and lowering and rotation of the support part 33 may be automatically controlled by a main control part 150 to be described below. When it is difficult to obtain characters or symbols from the image information of the label B1 obtained from the vision sensor part 50, the main control part 150 may move up/down or rotate the support part 33 so that the vision sensor part 50 obtains an appropriate angle of view to photograph the label B1 of wine.

Meanwhile, the front surface of the inner casing 30 may be open, and the storage space 32 may also be open forward, and the open portions may be covered by the door 42. The door 42 may be installed on the front surface of the inner casing 30 corresponding to the opposite side of the cooling device C with the storage space 32 placed between the door and the cooling device, and may be made of a heat insulating material.

Looking at the door 42 constituting one side of the insulated space, the door 42 may cover the storage space 32 together with the cooling guide 40 provided in the inner casing 30. More specifically, the cooling guide 40, the door 42, and the bottom part 31b may together define the storage space 32, and the upper part of the storage space 32 may be selectively covered by a cover assembly 90 and the door 42.

The door 42 may open the storage space 32 while swinging. As illustrated in FIG. 3, when the door 42 is opened, the storage space 32 may be open so that the wine bottle B can be accommodated in the storage space 32.

Referring to FIG. 3, the door 42 may be composed of at least one insulating glass. In the present embodiment, the door 42 may be composed of a first panel 43 and a second panel 44, each of which is insulating glass. Accordingly, a user may see the storage space 32 through the transparent first panel 43 and second panel 44 and observe the wine bottle B stored in the storage space 32. A user may check the type of beverage stored in the storage space 32 through the door 42. An empty space may be defined between the first panel 43 and the second panel 44, and a vacuum may be formed in the empty space.

Next, looking at the cooling device C, the cooling device C may be installed in the installation space S and may serve to lower the temperature of the storage space 32. When the temperature of the storage space 32 decreases, the temperature of the wine bottle B stored in the storage space 32 may also decrease. In the present embodiment, at least a portion of the cooling device C may contact the inner casing 30 surrounding the storage space 32 so as to improve cooling performance. For example, the cooling device C may be in contact with the cooling guide 40.

The cooling device C may be installed adjacently to the storage space 32 to lower the temperature of the storage space 32, and may be installed in various locations except a position between the storage space 32 and the door 42. For example, the cooling device C may be installed on the left and right sides of the storage space 32 or on the rear side of the storage space 32. In the present embodiment, the cooling device C may cool the cooling guide 40, and accordingly, the storage space 32 located inside the cooling guide 40 may be cooled.

Preferably, as illustrated in FIG. 3, the cooling device C may be installed at the rear of the storage space 32 corresponding to the opposite side of the door 42. When the cooling device C is installed at the rear of the storage space 32, one side of the cooling device C may face the introduction grille 15 and the discharge grille 16 provided on the rear plate 13, thereby increasing cooling efficiency. Additionally, in the present embodiment, since the widest installation space S is secured at the rear of the storage space 32, it is easy to install the cooling device C.

The cooling device C may include multiple cooling devices. More specifically, the number of the cooling devices C may be the same as the number of the storage spaces 32. In the present embodiment, since the storage space 32 includes two storage spaces, the cooling device C may include two cooling devices. The multiple cooling devices C may serve to lower the temperatures of the separate storage spaces 32, respectively. Accordingly, the multiple storage spaces 32 may be independently cooled because internal temperatures thereof may be preset to be different.

In the present embodiment, the cooling device C may include a thermoelectric element (reference numeral not given), and the thermoelectric element can maintain the temperature of the storage space 32 low by utilizing a Peltier effect. In addition, the cooling device C may have a structure for effectively cooling the storage space 32 by connecting the low-temperature part of the thermoelectric element toward the storage space 32 and dissipating heat from a high-temperature part thereof. Alternatively, the cooling device C may constitute a refrigeration cycle including a compressor, a condenser, an evaporator, and the like.

The vision sensor part 50 may be disposed in the door 42. The vision sensor part 50 is for acquiring information on wine from a label B1 of the wine by capturing the label B1. The vision sensor part 50 may include a video camera.

That is, the vision sensor part 50 may obtain an image through the camera corresponding to the human eye and may be used to obtain various information (a place of origin, a type, a production year, and brand name, etc.) which the image has. Furthermore, the vision sensor part 50 may transfer the acquired image to a main control part 150, and an image processing part 154 included in the main control part 150 or connected to the main control part 150 may finally obtain necessary information through an image processing process of extracting features (characters, symbols, etc.) by using mathematical techniques.

In the present embodiment, the vision sensor part 50 may be disposed on an inner surface of the door 42. That is, the vision sensor part 50 may be disposed to face the storage space 32 when the door 42 is closed. Accordingly, when the door 42 is completely closed or partially closed, the vision sensor part 50 may capture the label B1 of the wine bottle B stored in the storage space 32.

The vision sensor part 50 may be installed on the inner surface of the door 42 at a height suitable for the height of the label B1 (see FIG. 1), or may be disposed on the lower part of the door 42 (see FIGS. 5 to 7). When the vision sensor part 50 is disposed at the middle height of the door 42, the vision sensor part 50 may capture the label B1 more accurately by facing the label B1. When the vision sensor part 50 is disposed on the lower part of the door 42, the capturing angle of the vision sensor part 50 may be adjusted upward to face the label B1.

Alternatively, the vision sensor part 50 may be installed on the upper part of the door 42 or may be disposed inside the storage space 32 instead of the door 42. Furthermore, the vision sensor part 50 may be disposed not on the door 42 but on the front upper part of the wine storage device corresponding to the upper part of the door 42. In this case, when the wine bottle B is placed in front of the door 42 so that the label B1 faces the inside of the storage space 32, the vision sensor part 50 may capture the label B1.

FIGS. 5 to 7 illustrate that the label B1 of the wine bottle B is photographed through the vision sensor part 50. First, referring to FIG. 5, when a user opens the door 42 and places the wine bottle B inside the door 42, the vision sensor part 50 may capture the label B1. FIG. 5 illustrates a state in which the wine bottle B is disposed on the support plate 27 without being accommodated in the storage space 32. Alternatively, the label B1 of the wine bottle B may be captured by the vision sensor part 50 while the wine bottle B is accommodated in the storage space 32.

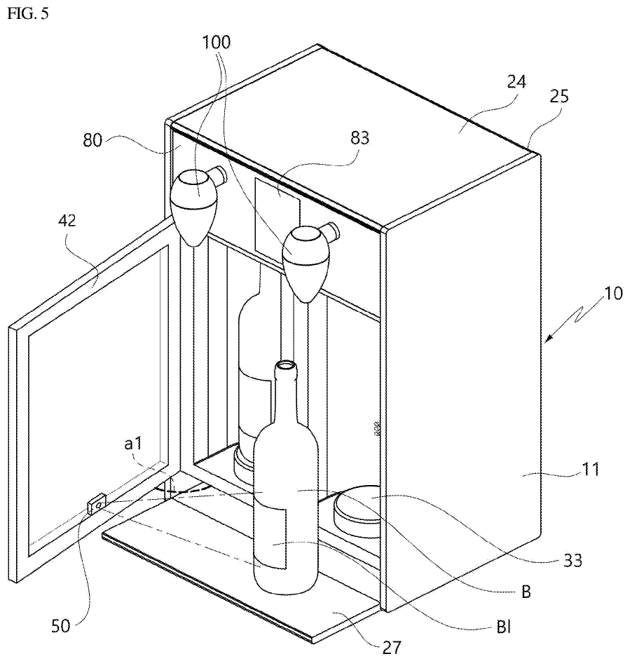

In this case, when the vision sensor part 50 has an angle of view difficult to accurately photograph the label B1, the angle of view of the vision sensor part 50 may be changed by adjusting the opening angle of the door 42. Comparing FIGS. 5 and 6, angles a1 and a2 formed by the door 42 and the front surface of the cabinet 10 may be different from each other, and accordingly, the angle of view of the vision sensor part 50 may also change.

In this case, when the vision sensor part 50 fails to extract characters or symbols included in the label B1 image, the main control part 150 may allow a user to recognize the result of extraction failure through a display device provided in the cabinet 10. Here, the extraction of characters and symbols may be performed by the image processing part 154 connected to the main control part 150. When the image processing part 154 fails to acquire the characters and symbols, this may be notified to a user. Acquisition of characters and symbols by the image processing part 154 and control of the display device may be performed by the main control part 150.

Here, the display device may be a display 83 provided on a front panel 80 of the cabinet 10 or a speaker (not shown). When a user finds that the angle of view of the vision sensor part 50 is not suitable through the display device, the user may adjust the angle of the door 42 to change the angle of view.

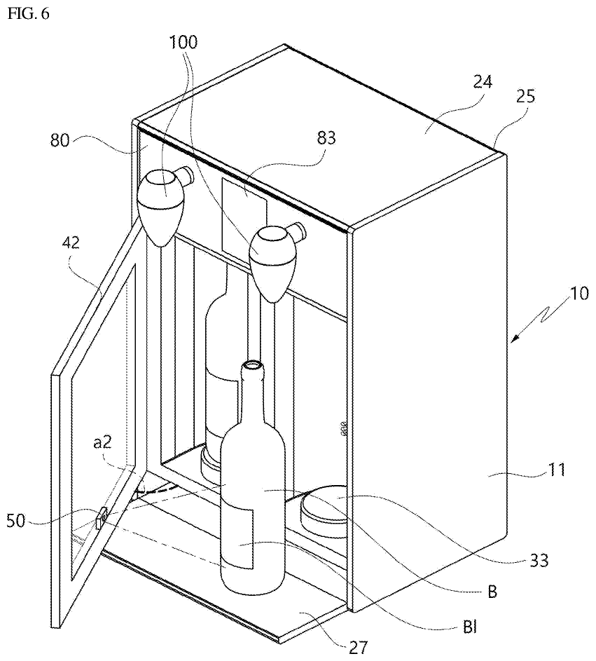

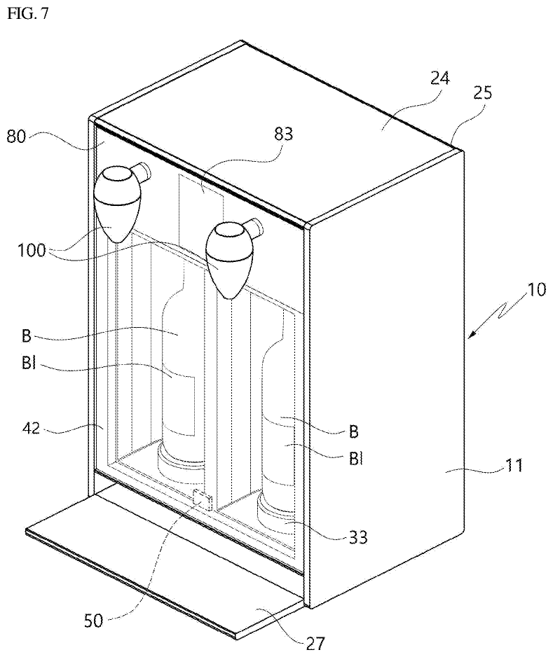

Looking at FIG. 7, a state in which the wine bottle B is stored in the storage space 32 is shown. Even in this state, the label B1 may be photographed through the vision sensor part 50. Compared with FIGS. 5 and 6, when the wine bottle B is stored in the storage space 32 as shown in FIG. 6, a distance between the vision sensor part 50 and the label B1 may be close, but there may be a space therebetween, so the vision sensor part 50 may capture the label B1.

When the acquisition of characters and symbols by the image processing part 154 fails, the main control part 150 may automatically change the angle of view of the vision sensor part 50 by moving up or down or rotating the support part 33.

In addition, when the acquisition of the information of the label B1 from an image captured by the vision sensor part 50 fails, a user may directly photograph the label B1 by using a user terminal. The image captured by the user terminal may be transmitted to the main control part 150 or to an external server through a communication module 156.

Referring to FIG. 8, a spectral sensor part 55 may be disposed inside the cabinet 10. The spectral sensor part 55 may measure spectral light from the wine and provide measured information to the main control part 150. The main control part 150 may obtain information about the wine through the measured information. Here, the wine information means information about the current state of the wine.

That is, the sugar content, pH (hydrogen ion concentration), alcohol concentration, and tannin concentration, etc. of the wine may be said to be information on the current wine. Since this current wine information may change from moment to moment, the information will be referred to as variable conditions to distinguish the information from fixed conditions obtained by the vision sensor part 50 above.

In order to obtain the variable conditions of the wine, the spectral sensor part 55 may be disposed in the path of a dispensing pipe Pa through which wine contained in the wine bottle B is dispensed. Referring to FIG. 8, the dispensing pipe Pa for dispensing wine may be connected to the wine bottle B, and the spectral sensor part 55 may be disposed at a position adjacent to an end part Pa′ extending from the dispensing pipe Pa.

The spectral sensor part 55 may shine light on the transparent dispensing pipe Pa, and may measure a unique wavelength spectrum absorbed, reflected, and transmitted from wine contained in the dispensing pipe Pa to identify characteristics of the wine. Likewise, the spectral sensor part 55 may not directly analyze the components of wine, but analyze the wavelength spectrum of wine to obtain characteristics of the wine in a non-contact manner.

As illustrated in FIG. 9, the spectral sensor part 55 may include a light source 56 for emitting light to the end part Pa′ of the dispensing pipe Pa, and a spectrometer 57 for analyzing light reflected from wine contained in the end part Pa′. Furthermore, the light source 56 and the spectrometer 57 may be installed on one substrate 58. The principal component analysis (PCA) of median normalized microarray data obtained through the spectrometer 57 may be performed through the substrate 58. Here, the substrate 58 may be a part of the main control part 150.

In this case, spectral data obtained through the spectral sensor part 55 may be mathematically preprocessed by limiting gap for each wavelength to a specific value. In addition, a calibration equation may be derived by applying a first-order differentiation method to the preprocessed spectrum to perform a numerical treatment of the spectrum, and performing the regression analysis of the numerically treated spectrum by using a partial least square (PLS) method. This method is just one example, and the wavelength spectrum of wine obtained through the spectral sensor part 55 may be analyzed in various ways.

The information analyzed by the spectral sensor part 55 may include the sugar content, pH (hydrogen ion concentration), alcohol concentration, and tannin concentration of the wine. Among them, the acidity of wine may be measured through pH (hydrogen ion concentration), and the amount of alcohol contained in the wine may be measured by analyzing the amount of chromium oxide (Cr(III)).

In the previous embodiment, the spectral sensor part 55 is disposed adjacently to the dispensing pipe Pa, which is a path through which wine is dispensed. However, unlike this, the spectral sensor part 55 may be disposed in a measuring tank (not shown) in which a part of the wine is temporarily stored. The main control part 150 may move the wine in the wine bottle B to the measuring tank at predetermined time intervals and may periodically check the state of the wine through the spectral sensor part 55.

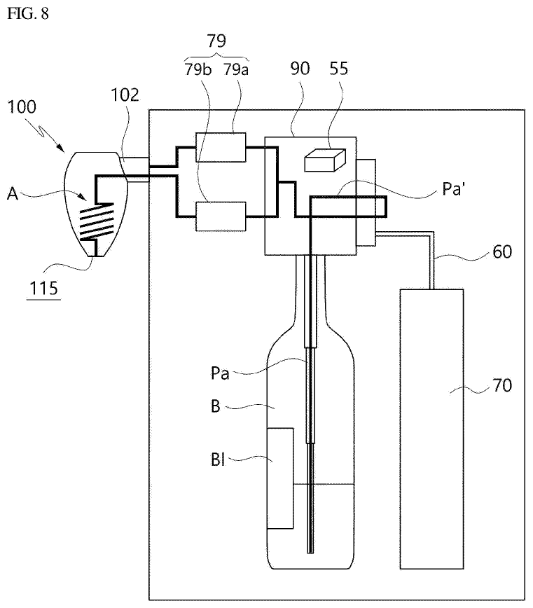

Next, referring to FIG. 10, a wine dispensing structure mounted in the cabinet 10 will be described. FIG. 10 illustrates the structure of a supply pipe 60 for dispensing wine. For reference, the supply pipe 60 is intended to supply high-pressure air or inert gas to an injection pipe Pb, and may be installed in the installation space of the cabinet 10. In FIG. 10, the cabinet 10 and the inner casing 30 are omitted for ease of understanding.

The supply pipe 60 may be installed by crossing the inner space of the cabinet 10 and may be composed of multiple tubes. More specifically, the supply pipe 60 includes a pump connection line 61 coupled to an air pump 70 and a tank connection line 62 coupled to a gas tank 71. The pump connection line 61 and the tank connection line 62 may be installed in a position close to the rear plate 13 in the installation space of the cabinet 10.

In addition, the pump connection line 61 and the tank connection line 62 may be connected to a first valve 63, which is a three-way valve, and a main supply line 64 may be connected to the first valve 63. Accordingly, through the manipulation of the first valve 63, one of the pump connection line 61 and the tank connection line 62 may be connected to the main supply line 64. For example, due to the operation of the first valve 63, (i) when the pump connection line 61 and the main supply line 64 are connected to each other, air pressure increased in the air pump 70 is transferred to the main supply line 64, and (ii) when the tank connection line 62 and the main supply line 64 are connected to each other, an inert gas from the gas tank 71 is transferred to the main supply line 64.

The main supply line 64 may be again divided through branch lines 66A and 66B. The branch lines 66A and 66B may be intended to divide the main supply line 64 into several branches, and the number of the branch lines 66A and 66B may be equal to the number of the storage spaces 32, that is, the number of wine bottles B stored in the storage spaces 32. In the present embodiment, two branch lines 66A, 66B are provided.

In this case, a second valve 65 may be installed between the main supply line 64 and the two branch lines 66A and 66B. The second valve 65 may be configured as a three-phase valve, and may selectively connect the main supply line 64 to any one of the two branch lines 66A and 66B.

The branch lines 66A and 66B may be respectively connected to connection assemblies 78 to be described below, and each of the connection assemblies 78 may be connected to the injection pipe Pb and a dispensing pipe Pa described above. As a result, through the connection assembly 78, the injection pipe Pb and the branch lines 66A, 66B may be connected to each other, and the dispensing pipe Pa and the supply pipe 60 may be connected to each other. Of course, when there is one storage space 32 and only one wine bottle B is stored therein, the branch lines 66A, 66B may be omitted, and the main supply line 64 may be connected directly to the connection assembly 78.

A control valve 64′ may be installed on the main supply line 64. Even if the air pump 70 does not operate when the first valve 63 is opened toward the air pump 70, the control valve 64′ may prevent air introduced from an air supply pipe 72 connected to the air pump 70 from being delivered to the injection pipe Pb, and may be installed at the center of the main supply line 64.

Meanwhile, the air pump 70 and the gas tank 71 may be installed inside the cabinet 10. The air pump 70 may be intended to supply high-pressure air to the main supply line 64 and may be operated by receiving power. When the air pump 70 injects high-pressure air into the wine bottle B through the main supply line 64, pressure inside the wine bottle B may increase, and beverage may be discharged through the dispensing pipe Pa. Accordingly, a beverage may be supplied to a user through the supply pipe 60.

The air pump 70 is installed at a position close to the bottom of the cabinet 10 at the rear of the storage space 32. When the air pump 70 is located at the rear side, the degree of transmission of noise generated during operation of the air pump 70 to the front side may be reduced.

The air supply pipe 72 may be connected to the air pump 70, and one side of the air supply pipe 72 may be open so that the air supply pipe 72 can receive air from the outside. In the present embodiment, although the air pump 70 is operated by power as an example, the air pump 70 may have a tank structure in which high-pressure gas is prepared in a compressed state.

The gas tank 71 may have an inert gas inside, and may selectively supply the inert gas to the wine bottle B through the main supply line 64. When the inert gas is injected into the wine bottle B through the injection pipe Pb, the oxidation of a beverage due to oxygen present in the wine bottle B may be prevented. Such an inert gas may include an inert gas such as nitrogen, helium gas, argon gas, and carbon dioxide, or a mixture of at least one of the above gases.

In the present embodiment, the gas tank 71 is only for the purpose of preventing the oxidation of a beverage, and the air pump 70 described above is responsible for dispensing wine. Accordingly, since the inert gas of the gas tank 71 is only intermittently injected into the wine bottle B, the consumption rate of the gas tank 71 may be reduced. Alternatively, the air pump 70 may be omitted, and the gas tank 71 may also be in charge of dispensing wine.

The gas tank 71 may be accommodated inside the cabinet 10 in a direction in which the gas tank 71 is erected through a tank mounting hole 23 formed in the upper cover 20 of the cabinet 10. The tank mounting hole 23 may be made through the upper cover 20 like an open hole 22, and may be formed closer to the rear plate 13 than to the open hole 22.

Since the gas tank 71 is installed in the tank mounting hole 23, the tank mounting hole 23 may be selectively covered by the door 42. That is, a portion of the gas tank 71 is exposed in FIG. 1, but when the door 42 is closed, the gas tank 71 is not exposed to the outside. Conversely, when only the door 42 is opened, a user may easily separate the gas tank 71 from the tank mounting hole to replace the same.

In the present embodiment, the gas tank 71 and the air pump 70 may be installed inside the cabinet 10, but otherwise, the gas tank 71 and the air pump 70 may be prepared as separate objects outside the cabinet 10. In this case, the supply pipe 60 may be further extended to the outside of the cabinet 10 and connected to the gas tank 71 and the air pump 70.

Meanwhile, a temperature adjustment module 79 may be provided inside the cabinet 10. The temperature adjustment module may serve to adjust the temperature of wine being dispensed. As illustrated in FIG. 8, the temperature adjustment module 79 may be disposed at a position adjacent to the spectral sensor part 55 and may be a path through which wine analyzed by the spectral sensor part 55 is dispensed.

The temperature adjustment module includes a heating unit 79a and a cooling unit 79b, and the heating unit 79a and the cooling unit 79b may form independent paths. In the present embodiment, the heating unit 79a and the cooling unit 79b may be arranged in parallel with each other between the end part Pa of the dispensing pipe Pa and the dispensing head 100, and wine may be delivered to the dispensing head 100 after passing through the heating unit 79a or the cooling unit 79b.

The front panel 80 may be disposed at a position adjacent to the dispensing head 100. The front panel 80 may be disposed on the upper part of the front surface of the cabinet 10. In the present embodiment, the front panel 80 may extend to be long left and right. The front panel 80 may be provided on the upper part of the front surface of the cabinet 10 and may be formed in a flat plate shape. Parts including the injection pipe Pb may be disposed behind the front panel 80. In the present embodiment, the front panel 80 may be located inside the second panel 44 of the door 42, which is located relatively outside, as described above. Unlike this, the height of the second panel 44 may be lower, and the front panel 80 may fill the remaining portion.

The display 83 may be provided on the front panel 80. The display 83 may provide information on the wine storage device or provide an interface for inputting a command. In the present embodiment, the display 83 may receive a touch input.

The display 83 may display various information such as the temperature of the storage space 32, the storage period of a stored beverage, and the type of a beverage, and a user may input information about desired aerating intensity, the temperature of the storage space 32, brightness of internal light, and the power on/off of a refrigerator, etc.

In addition, various information on the wine measured by the vision sensor part 50 and the spectral sensor part 55 may be displayed on the display 83. For example, the display 83 may display information on the type, place of production, and year of production of the wine obtained from the vision sensor part 50, and at least one information of sugar content, pH (hydrogen ion concentration), alcohol concentration, and tannin concentration of the wine transmitted from the spectral sensor part 55.

Aerating intensity automatically preset by the main control part 150 to suit the characteristics of the wine may be displayed through the display 83. Apart from this, a user may input desired aerating intensity through the display 83 which is an input part. Aerating part A may discharge wine with aerating intensity input by a user. In addition, a database 152 may store aerating intensity input by a user, and the main control part 150 may learn the aerating intensity.

The dispensing head 100 may be provided on the cabinet 10. The dispensing head 100 may serve to discharge wine contained in the wine bottle B to the outside. In the present embodiment, the dispensing head 100 may protrude from the upper part of the front surface of the cabinet 10 and may include two dispensing heads. The two dispensing heads 100 may respectively be connected to separate wine bottles B.

The dispensing head 100 may be connected to the dispensing pipe Pa coupled to the connection assembly 78. Wine supplied to the dispensing pipe Pa may be supplied to the outside through a wine outlet 115 formed in the dispensing head 100. A nozzle connection pipe 102 may be connected to the dispensing head 100, and may serve to supply wine by being connected to the end part Pa′ of the dispensing pipe Pa described above.

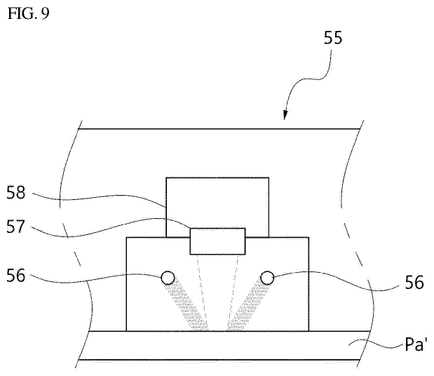

Referring to FIG. 11, a contact space 113 may be formed inside [symbol] the dispensing head 100. The contact space may be an empty space for increasing the amount of contact of wine with air in the process of discharging the wine discharged through the dispensing pipe Pa to the outside. That is, in the contact space 113, wine may be aerated.

The dispensing head 100 may have the wine discharge hole 115 open on the lower part thereof and a head fixing part 112 provided on the upper part thereof. The head fixing part 112 may be a part for connecting the dispensing head 100 to the cabinet 10, and the end part of the dispensing pipe Pa may be mounted inside the head fixing part 112.

The aerating part A may be disposed inside the contact space 113. The aerating part A may be intended to aerate the wine. According to the present embodiment, the aerating part A may adjust the aerating intensity of the wine. That is, the aerating part A allows the aerating intensity to be changed through a user's selection or the automatic control of the main control part 150. The aerating part A may adjust at least one of the size, length, number, and direction of a discharge hole 143 to be described below.

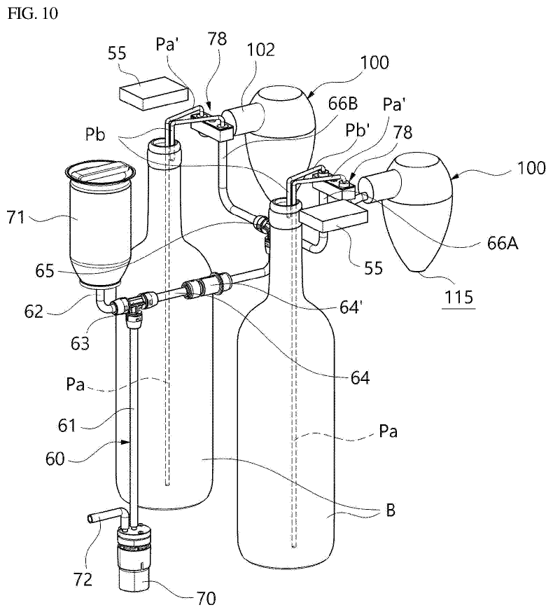

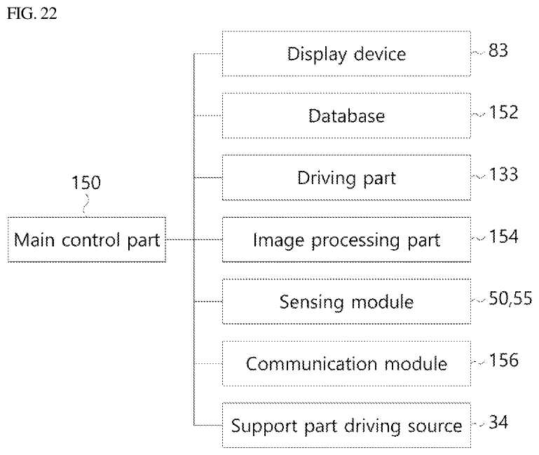

FIGS. 11 and 12 show a first embodiment of the aerating part A. While the aerating part A is operated by a driving part 133 (see FIG. 22) controlled by the main control part 150, the number of exposed discharge holes of the discharge holes 143 through which wine is discharged may be adjusted. Here, the discharge holes 143 may be formed in a discharge body 140 to be described below, and all or part of the wine may be discharged through the discharge holes 143.

More specifically, the aerating part A may be provided with a main dispensing pipe 120. The main dispensing pipe 120 may be connected to the dispensing pipe Pa and may extend vertically inside the contact space 113. The upper end of the main dispensing pipe 120 may be connected to the center of the head fixing part 112, and the lower end of the main dispensing pipe 120 may be open toward the inside of the contact space 113. In this case, an open part 122 of the lower end of the main dispensing pipe 120 may be open toward the wine discharge hole 115. In this case, wine discharged through the main dispensing pipe 120 may be discharged directly to the wine discharge hole 115.

The head fixing part 112 may be provided with an opening and closing body 130. The opening and closing body 130 may be disposed inside the head fixing part 112 and may be moved up and down by the driving part 133. In the present embodiment, the opening and closing body 130 may be formed in a cylindrical shape and may move up and down along the main dispensing pipe 120.

The discharge body 140 may be disposed inside the opening and closing body 130. The discharge body 140 may be surrounded by the opening and closing body 130, but unlike the opening and closing body 130, may have a fixed structure in which the discharge body 140 does not move up and down. Accordingly, due to the upward and downward movement of the opening and closing body 130, the outer surface area of the opening and closing body 130 exposed to the contact space 113 may change.

Multiple discharge holes 143 may be formed in the discharge body 140. The discharge hole 143 may serve to discharge wine delivered from the dispensing pipe Pa into the contact space 113. To this end, the discharge holes 143 may be open toward the contact space 113. In the present embodiment, each of the discharge holes 143 is open in a direction (a left-to-right direction) orthogonal to a direction (an up-to-down direction) in which the opening and closing body 130 is raised and lowered. Accordingly, the discharge hole 143 may discharge wine in an oblique direction with respect to the direction of gravity.

Multiple discharge holes 143 may be formed in the discharge body 140. The multiple discharge holes 143 may be disposed on the outer circumferential surface of the discharge body 140. At the same time, the discharge holes 143 may be disposed at different heights of the discharge body 140. In this case, when the opening and closing body 130 is raised or lowered by the driving part 133, at least a portion of the discharge holes 143 may be exposed to the contact space 113, but the remaining portion thereof may be maintained in a covered state by the opening and closing body 130.

When wine is discharged through the discharge holes 143, the amount of contact of the wine with air existing in the contact space 113 may increase. That is, in the contact space 113, wine may be aerated. Furthermore, since the opening amount of the discharge holes 143 is changed through the raising and lowering of the opening and closing body 130, the aerating intensity may be adjusted.

Specifically, FIG. 12(a) shows a state in which the opening and closing body 130 is completely lowered and the discharge holes 143 are completely covered. Accordingly, wine may move along only the main dispensing pipe 120 and be provided to a user through the wine discharge hole 115.

Alternatively, when the opening and closing body 130 rises as shown in FIG. 12(b), among the discharge holes, the discharge holes 143 disposed at the lowest end of the discharge body 140 may be exposed. Furthermore, some of the wine may be discharged through the exposed discharge holes 143. After the discharged wine comes into contact with air in the contact space 113, the wine may fall due to gravity and be discharged to the wine discharge hole 115.

In this case, the main dispensing pipe 120 may be blocked by the driving part 133. Accordingly, wine may not be discharged through the main dispensing pipe 120 but be discharged only through the discharge holes 143. In this case, since the amount of contact of wine with air increases, the aerating intensity may be further increased.

Finally, referring to FIG. 12(c), the opening and closing body 130 is further raised, and more of the discharge holes may be exposed to the contact space 113. Accordingly, since the amount of contact of wine with air in the contact space 113 increases, the aerating intensity further may increase.

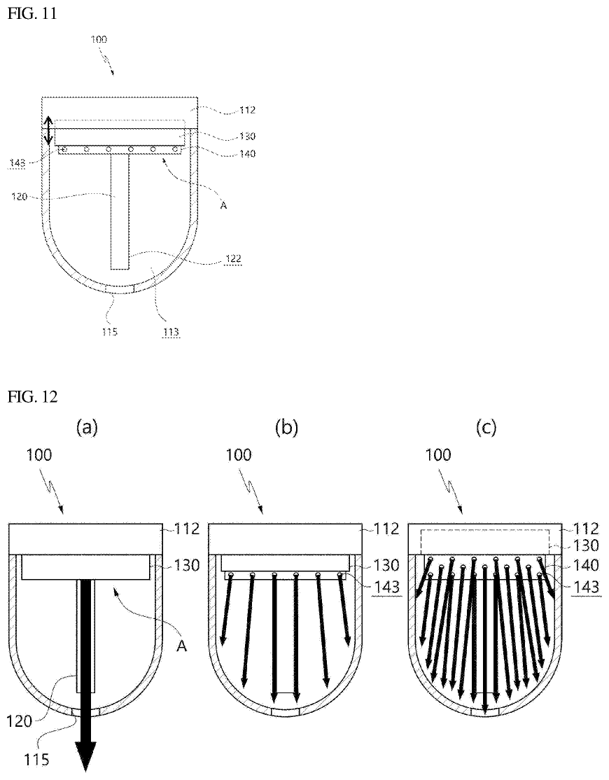

Meanwhile, FIGS. 13 and 14 illustrate a second embodiment of the aerating part A. Hereinafter, a structure different from that of the first embodiment will be mainly described, and the same structure will be given a reference numeral starting from 200 and description thereof will be omitted.

As illustrated in FIG. 13, the aerating part A may be disposed in a contact space 213 of a spherical or disk shape. The contact space 213 may be regarded as a part of a dispensing head 200, but may also be regarded as being formed in the aerating part A. For example, the aerating part A may include an inner casing 211 of a spherical shape, and the contact space 213 of a spherical shape may be provided inside the inner casing 211.

The aerating part A may include a rotary dispensing pipe 220. The rotary dispensing pipe 220 may be rotatably provided inside the contact space 213, and a discharge hole 223 may be formed inside the rotary dispensing pipe 220 along a longitudinal direction thereof. Since wine can be discharged through the discharge hole 223, the rotary dispensing pipe 220 may be regarded as the main dispensing pipe. Furthermore, the rotary dispensing pipe 220 may be rotated inside the contact space 213 by the driving part 133. Reference numeral 225 denotes a rotation axis of the rotary dispensing pipe 220.

An upper end 221 of the rotary dispensing pipe 220 may face a head fixing part 212, and a lower end 222 thereof may face a wine discharge hole 215. In other words, when the rotary dispensing pipe 220 is in a first state in which the rotary dispensing pipe 220 is erected, the discharge hole 223 may be opened toward the wine discharge hole 215, which is a discharge part of the dispensing head 200. When the rotary dispensing pipe 220 is in the first state, wine may move downward through the discharge hole 223 and may be discharged to the wine discharge hole 215, and a user may receive the wine. Such a state is shown in FIG. 14(a).

Meanwhile, when the rotary dispensing pipe 220 is rotated by the driving part 133, the rotary dispensing pipe 220 may be in a second state which is a rotated state. When the rotary dispensing pipe 220 is in the second state, the lower end 222, which is one end of the discharge hole 223, may not correspond to the wine discharge hole 215 and thus may open toward the inner surface of the contact space 213. Accordingly, wine may not directly be transferred from the discharge hole 223 to the wine discharge hole 215, but may be first discharged into the contact space 213, may fall due to gravity to exit the inner casing 211, and then may be transferred to the wine discharge hole 215. Such a state is shown in FIG. 14(b).

In this way, when the rotary dispensing pipe 220 is in the second state, the amount of contact between the wine and air may increase, and the aerating intensity may increase. In this case, by changing the rotation angle of the rotary dispensing pipe 220, the aerating intensity may be further subdivided. For example, when the rotary dispensing pipe 220 is laid in a horizontal direction, that is, in the left and right directions, wine may not directly be injected into the wine discharge hole 215, but may be discharged through the contact space 213 to the wine discharge hole 215, so the aerating intensity may be further increased.

In this case, since entire length of the rotary dispensing pipe 220 is shorter than an inner diameter of the contact space 213, opposite ends of the rotary dispensing pipe 220 may be spaced apart from the inner surface of the contact space 213. In addition, wine may be aerated while passing through a gap between the rotary dispensing pipe 220 and the inner surface of the contact space 213. Of course, the diameter of the rotary dispensing pipe 220 may be equal to the inner diameter of the contact space 213, so there may be no gap therebetween.

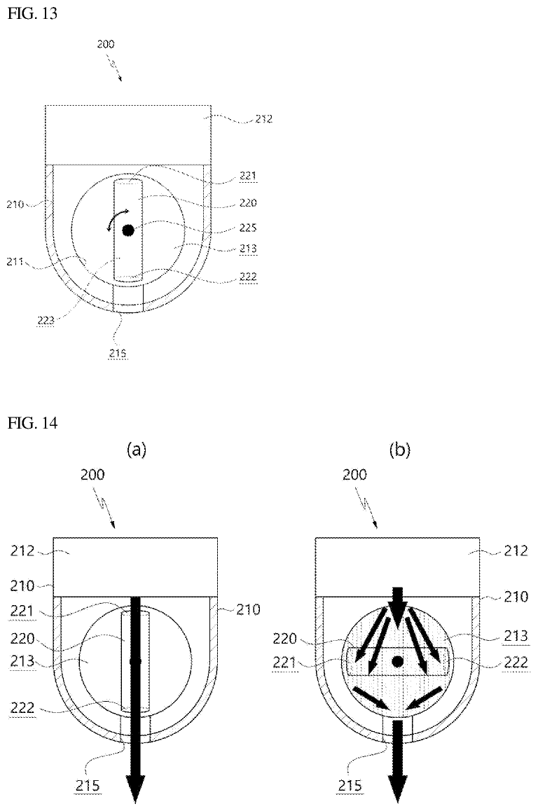

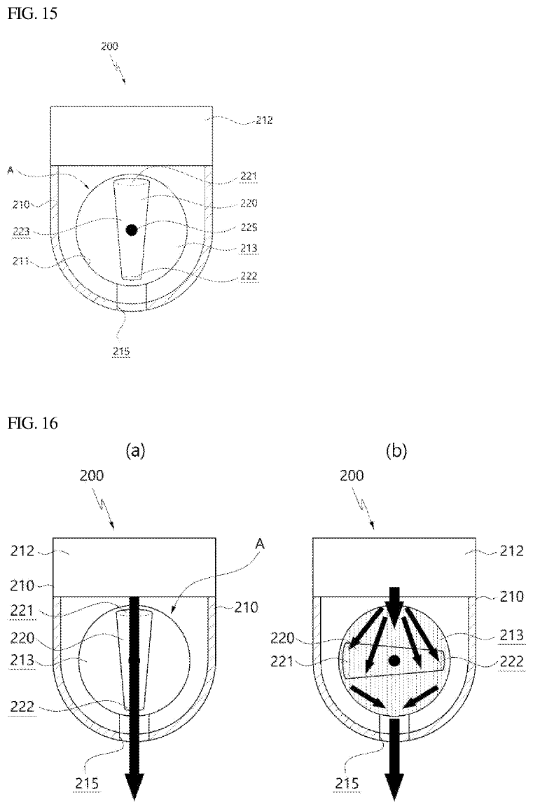

Next, a third embodiment of the aerating part A will be described with reference to FIGS. 15 and 16. As shown in FIG. 15, the structure of the aerating part A of the third embodiment is similar to the structure of the aerating part A of the second embodiment described above.

A discharge hole 223 may be formed in the rotary dispensing pipe 220 of the aerating part A along a longitudinal direction thereof. Furthermore, an inlet of the rotary dispensing pipe 220 which is the upper end 221 of the rotary dispensing pipe 220 connected to the wine bottle B may have a larger inner diameter than an outlet of the rotary dispensing pipe 220 which is the lower end 222 of the rotary dispensing pipe 220 discharging the wine. That is, as illustrated in FIG. 15, the rotary dispensing pipe 220 may have a shape of an approximately truncated cone.

The inlet of the rotary dispensing pipe 220 is large, and thus when the rotary dispensing pipe 220 is in the first state, wine delivered from the dispensing pipe Pa may not leak into the contact space 213 around, but may be discharged through the wine discharge hole. That is, when the rotary dispensing pipe 220 is in the first state, the aerating intensity may be reduced to a minimum.

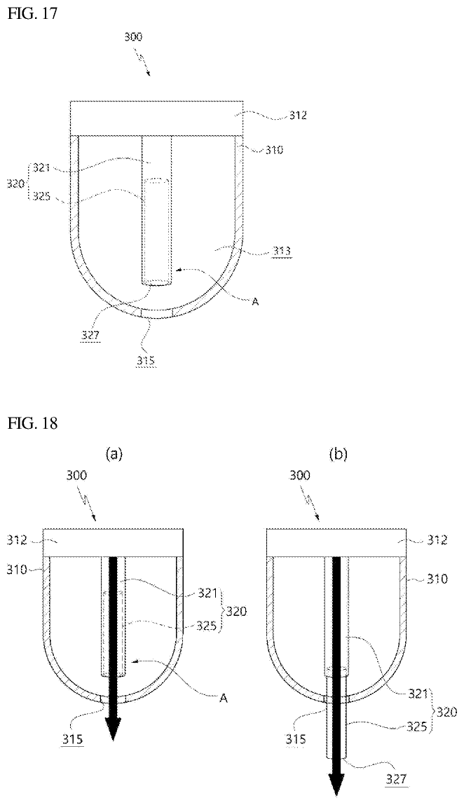

In addition, FIGS. 17 and 18 show a fourth embodiment of the aerating part A. As illustrated in the drawings, the aerating part A may have multiple dispensing pipes 320 which overlap or spread. Specifically, the aerating part A may include a first dispensing pipe 321 fixed in a contact space 313, and a second dispensing pipe 325 overlapping with the first dispensing pipe 321. The second dispensing pipe 325 may be connected to the first dispensing pipe 321 and may overlap with the first dispensing pipe 321 or extend in a direction away from the first dispensing pipe 321. The second dispensing pipe 325 may be moved relative to the first dispensing pipe 321 by the driving part 133.

As illustrated in FIG. 18(a), when the second dispensing pipe 325 is in a first state in which the second dispensing pipe 325 is maximally inserted into the first dispensing pipe 321, the total length of the first dispensing pipe 321 and the second dispensing pipe 325 may be reduced. Accordingly, a path in which wine passing through the first dispensing pipe 321 and the second dispensing pipe 325 comes into contact with air may be shortened, and the aerating intensity of the wine may also be lowered.

Alternatively, as illustrated in FIG. 18(b), when the second dispensing pipe 325 is in a second state in which the second dispensing pipe 325 protrudes maximally to the outside of the first dispensing pipe 321, the total length of the first dispensing pipe 321 and the second dispensing pipe 325 may increase. Accordingly, a path in which the wine passing through the first dispensing pipe 321 and the second dispensing pipe 325 comes into contact with air may increase, and the aerating intensity may be increased.

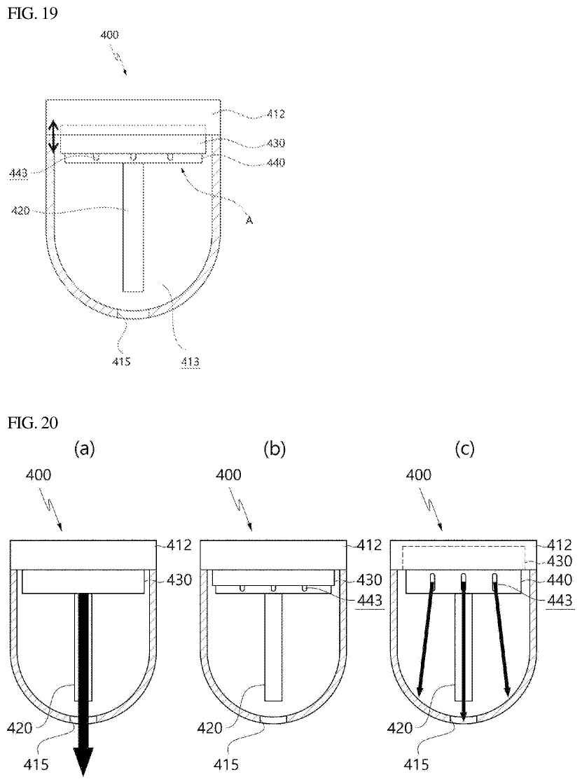

Finally, FIGS. 19 and 20 show a fifth embodiment of the aerating part A. The aerating part A has a structure similar to the structure of the aerating part of the first embodiment and can perform a similar operation. Compared with the first embodiment, although a discharge body 440 includes multiple discharge holes 443, the discharge holes 443 may be continuously connected along the ascending and descending direction of an opening and closing body 430.

The discharge holes 443 are connected in the vertical direction, and thus when the opening and closing body 430 moves up and down, a discharging area of the discharge holes through which wine is discharged into a contact space 413 may change. That is, as the opening and closing body 430 moves up and down, the number of the discharge holes 443 exposed to the inside of the contact space 413 may not change, but the exposed area of the discharge holes 443 may change. In the present embodiment, the discharge hole 443 may include multiple discharge holes, or may include one discharge hole.

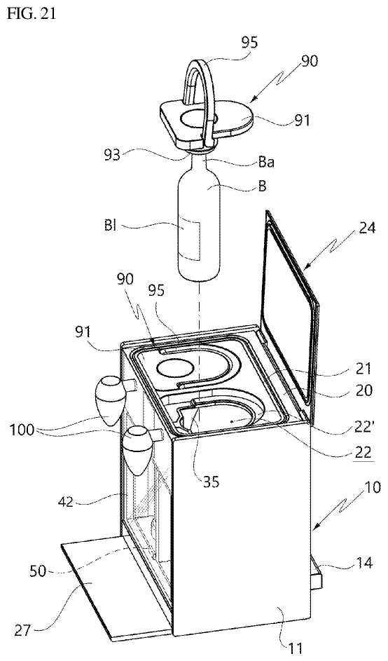

Meanwhile, FIG. 21 shows another embodiment of the door 42. In the previous embodiment, the door 42 constitutes the front surface of the cabinet 10, whereas in the present embodiment, the door 42 may constitute the upper surface of the cabinet 10. FIG. 21 illustrates a state in which the cover assembly 90 serving as the door 42 is assembled with the inlet Ba of the wine bottle B.

Specifically, the inlet Ba of the wine bottle B in an open state may be fitted into the cover assembly 90. The cover assembly 90 may serve to block the inlet Ba of the wine bottle B and at the same time, may serve to cover the open hole 22 located in the center of the upper cover 20.

Additionally, when a user raises the cover assembly 90, the wine bottle B fitted into the cover assembly 90 may also come out of the storage space 32 together. Conversely, after fitting the wine bottle B into the cover assembly 90, the wine bottle B may be received in the storage space 32. Accordingly, the cover assembly 90 may also function as a kind of handle.

Looking at the components of the cover assembly 90, the cover assembly 90 may include a cover plate 91 for covering the open hole 22, and a coupling part 93 extending downward from the cover plate 91 so that the inlet Ba of the wine bottle B is fitted into the coupling part. Furthermore, a handle part 95 may be rotatably assembled with the cover plate 91, and when the handle part 95 is rotated and is erected, a user may grip the handle part.

The cover plate 91 may be a part that is held by and fixed to the edge of the open hole 22 of the upper cover 20. In the present embodiment, the cover plate 91 may have an approximately plate-like structure. One side of the cover plate 91 may be rectangular, and the other side thereof may be formed in an arc shape, so the two sides may be asymmetrical to each other. Furthermore, the other side of the cover plate 91 formed in an arc shape may be surrounded by the handle part 95.

The cover plate 91 may cover the open hole 22 and a surrounding thereof, and thus when the cover assembly 90 is assembled to the upper cover 20, the cover assembly 90 may serves as a kind of inner door 42. Furthermore, when the cover assembly 90 is assembled to the upper cover 20, the cover assembly 90 may not be moved from the assembled position, so the inlet Ba of the wine bottle B fitted into the cover assembly 90 may be naturally fixed in an accurate position. Particularly, as illustrated in FIG. 21, a seating part 22′ around the open hole 22 and the cover plate 91 may be made in shapes corresponding to each other, and since the cover plate 91 has an asymmetrical front-to-rear structure, the cover plate 91 may be unlikely to be misassembled.

The coupling part 93, which is located on the lower side of the cover plate 91, may protrude downward from the cover plate 91 to be inserted into the open hole 22, more specifically, into the storage space 32 to some extent. The inlet Ba of the wine bottle B may be fitted into the coupling part 93 and may be covered.

When moving the wine bottle B by inserting the wine bottle B into the cover assembly 90, the handle part 95 may be used in an erected state as shown in FIG. 21, but may be rotated to form a continuous plane with the cover plate 91 after the wine bottle B is received in the storage space 32. That is, the handle part 95 may be regarded as constituting a portion of the cover plate 91.

In this case, when the handle part 95 is rotated and raised, a portion of the handle part 95 may transform the coupling part 93 so that the inlet Ba of the wine bottle B is strongly pressed to the inside of the coupling part 93 to be fixed.

Referring to FIG. 22, the main control part 150 and components controlled by the main control part 150 constituting the wine storage part according to the embodiment of the present disclosure are illustrated. As illustrated in the drawing, the main control part 150 may control the display device including the display 83 described above. Here, the display device may include a speaker as well as the display 83.

In addition, the main control part 150 may control the database 152. Wine information may be stored in the database 152. Here, the wine information may include not only fixed conditions obtained from the label B1 by the vision sensor part 50, such as the type of wine, but also variable conditions obtained by the spectral sensor part 55. That is, the variable conditions such as the current sugar content and acidity of wine may be stored in the database 152.

In addition, in the database 152, aerating intensity suitable for the fixed conditions and variable conditions of wine may be pre-stored, and the aerating intensity input by a user may be stored. Additionally, in the database 152, various pieces of information about wine received from an external server and the aerating of the wine may be stored, and stored information may be transmitted to the external server. The transmission and reception of such information may be performed by the communication module 156 mounted in the cabinet 10.

The driving part 133 of the aerating part A may be connected to the main control part 150. The main control part 150 may calculate an appropriate aerating intensity based on the information of the database 152 and drive the driving part 133 accordingly. Accordingly, the main control part 150 may adjust the aerating intensity of wine to be dispensed by the operation of the aerating part A. Of course, as described above, when the aerating intensity manually input by a user is stored in the database 152 to be learned, the main control part 150 may implement the aerating intensity of wine preferred by the user.

A sensing module may be connected to the main control part 150. The sensing module may include the vision sensor part 50 and the spectral sensor part 55 described above. Information measured by the vision sensor part 50 and the spectral sensor part 55 may be analyzed by the main control part 150 and then stored in the database 152. For example, the main control part 150 may include the image processing part 154 to obtain characters/symbols from an image obtained by the vision sensor part 50, and may include a spectral analyzer to obtain the acidity of the wine from the spectral information of the wine obtained by the spectral sensor part 55.

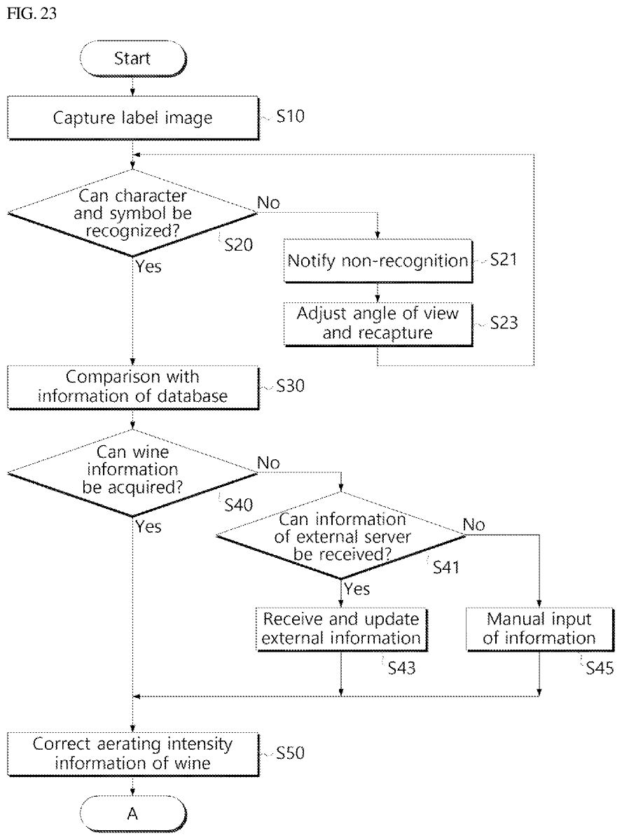

Next, referring to FIGS. 23 to 25, the process of controlling the aerating intensity of wine will be described. FIG. 23 illustrates the process of obtaining fixed information of wine. First, when a user places the wine bottle B in front of the vision sensor part 50, the vision sensor part 50 may recognize the label B1, capture the label B1, and transmit an image thereof to the image processing part 154 at S10.

In this case, the wine bottle B may be disposed inside the door 42. As illustrated in FIG. 3, the wine bottle B may be disposed in front of the door 42 open or may be received inside the storage space 32 to be photographed by the vision sensor part 50.

When the characters and symbols of the label B1 are not recognized by the vision sensor part 50 at S20, the main control part 150 may notify a user of the non-recognition at S21. The notifying a user of the non-recognition of the label B1 may be performed through the display 83 or a speaker. A user may know whether the label B1 is unrecognized by seeing an indication on the display 83 or listening to the guidance voice of the speaker.

In this case, the user may adjust the angle of view of the vision sensor part 50 by adjusting the opening angle of the door 42 or by adjusting a position at which the wine bottle B is placed so that the vision sensor part 50 can photograph the wine bottle B again at S23. Even in this process, the display 83 or the speaker may inform the user of an appropriate angle of view. Additionally, the support part driving source 34 may be operated by the main control part 150, and the view angle of the label B1 may be automatically adjusted while the support part 33 is moving up and down or rotating.

When the characters and symbols of the label B1 are recognized, the fixed conditions of the wine may be obtained and stored in the database 152. Furthermore, the main control part 150 may compare information pre-stored in the database 152 with newly obtained fixed conditions (information) of wine at S30

In addition, information of wine (fixed conditions) may be obtained from the compared information at S40. For example, information such as the type, place of origin, brand name, and production year of wine may be obtained. Furthermore, the obtained information may be stored in the database 152.

In this case, there may be cases in which information about wine photographed cannot be obtained from the information stored in the database 152. In this case, the main control part 150 may check whether information of wine can be obtained from the external server through the communication module 156 at S41. When the information of wine can be obtained, the main control part 150 may receive external information from the external server and update the wine information to the database 152 at S43.

When the external server cannot be accessed through the communication module 156, the main control part 150 may notify this to a user, and the user may directly input the information of the label B1 of wine (manual input) at S45. That is, through the display 83, which is the input part, a user may input the type and production year, etc. of wine displayed on the label B1 of the wine.

In addition, from the fixed conditions of the wine thus obtained, the aerating intensity may be selected at S50. The aerating intensity may be implemented by the main control part 150 reading information on the aerating intensity stored in the database 152 and driving the aerating part A based on the information.

For example, the aerating intensity according to the fixed conditions can be divided into a strong mode, a weak mode, and an off mode. (i) The strong mode may be applied to young red wines with astringent taste less than 8 years old, or red wines made from varieties of fruits with high tannins, and (ii) the weak mode may be applied to wines that have been aged for 8 years or more, or white wines that are free of lees but whose flavor can be enhanced by aeration just before tasting. In addition, (iii) the off mode may be applied to vintage wines that already have great flavor, white wines without tannins, or sparkling wines in which carbonation is important.

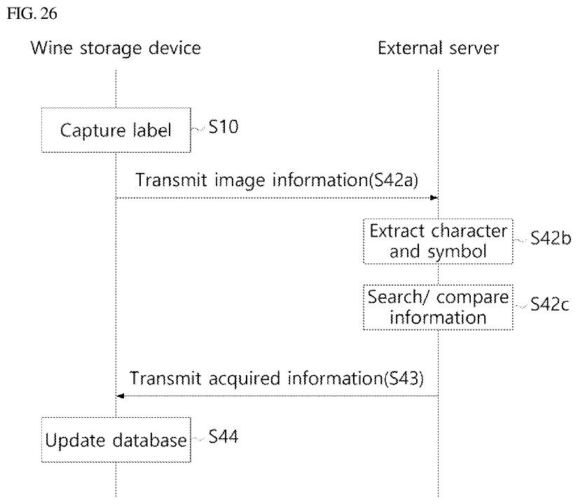

Meanwhile, the fixed conditions may be obtained by directly delivering the image of the label B1 of photographed wine to the external server. Referring to FIG. 26, the main control part 150 may send image information to the external server through the communication module 156 of the wine storage device at S42a, the external server may extract characters and symbols from the image information at S42b, and the fixed information of the wine may be obtained from the information stored in the external server at S42c. In addition, this information may be transmitted to the wine storage device again at S43, and the database 152 may be updated at S44.

Additionally, connection with the external server may be made through the user terminal as well as the communication module 156. That is, the communication module 156 may be connected wirelessly to the user terminal through wireless communication such as Bluetooth, Wi-Fi, and ZigBee, or a wired connection. The user terminal may transmit information of the database 152 to the external server, and information obtained from the external server may be stored in the database 152 via the user terminal.

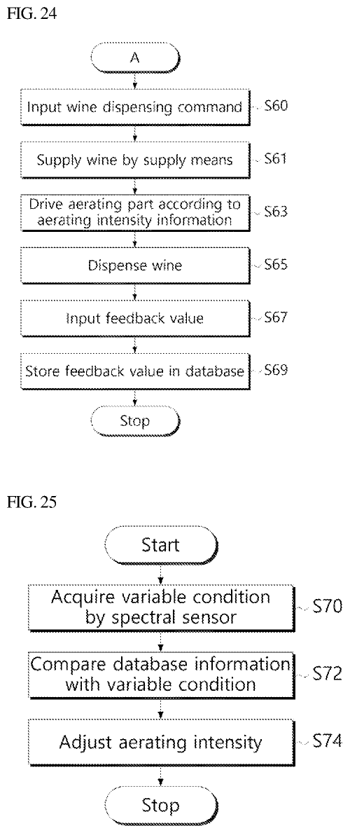

FIG. 24 sequentially illustrates a series of processes in which wine is dispensed. First, when a user inputs a wine dispensing command through the display 83 at S60, the main control part 150 may dispense wine contained in the wine bottle B through a supply means at S61. Here, the supply means may include the air pump 70.

In this case, the fixed information of wine acquired through the previous process and the aerating intensity based on the fixed information may be applied to the aerating part A at S63. The main control part 150 may drive the aerating part A based on automatically selected aerating intensity, and the aerating part A may bring wine to be dispensed into contact with air. The process has been described in detail above.

Wine aerated in this way may be dispensed through the wine discharge hole 115 of the dispensing head 100 at S65. A user may drink the wine and enter a feedback value at S67. That is, whether or not the wine is properly aerated may be input through the display 83, and the input value may be stored in the database 152 at S69. The main control part 150 may acquire aerating intensity preferred by the user by learning the input feedback value.

Meanwhile, as described above, the aerating intensity may be automatically adjusted with only the fixed conditions obtained by the vision sensor part 50, or may be automatically adjusted by considering the variable conditions obtained by the spectral sensor part 55.

Referring to FIG. 25, the variable conditions of wine may be obtained through the spectral sensor part 55 at S70. That is, the spectral sensor part 55 may obtain the variable conditions of wine by identifying characteristics of the wine by illuminating the transparent dispensing pipe Pa and measuring a unique wavelength spectrum absorbed, reflected, and transmitted from the wine contained in the dispensing pipe Pa. Likewise, the spectral sensor part 55 may not directly analyze the components of wine, but may indirectly obtain characteristics of the wine by analyzing the wavelength spectrum of the wine. Here, the obtained variable conditions may be variable conditions such as the current sugar content and acidity of wine.

The main control part 150 may compare information previously stored in the database 152 with newly obtained state (variable conditions) of wine at S72. In addition, the main control part 150 may derive the appropriate aerating intensity of wine that meets the variable conditions and may adjust the aerating intensity of the wine more precisely at S74.

In the above, all the components according to the embodiments of the present disclosure are described as being coupled to each other as one or being operated in the coupled state, but the present disclosure is not necessarily limited to the embodiments. That is, if it is within the scope of the present disclosure, at least one of all of the components may be selectively combined and operated. In addition, the terms such as “include”, “compose”, or “have” as described above means that the corresponding components can be inherent unless specifically stated to the contrary. Accordingly, it should be interpreted that other components are not excluded, but may further be included. All terms, including technical or scientific terms, have the same meaning as generally understood by those skilled in the art to which the present disclosure belongs, unless otherwise defined. Commonly used terms, such as terms defined in a dictionary, should be interpreted as being consistent with the contextual meaning of the related art, and are not to be interpreted as ideal or excessively formal meanings unless explicitly defined in the present disclosure.

1. A wine storage device comprising:
a cabinet having a storage space in which a wine bottle is received;
an image sensor configured to capture an image a label of the wine bottle;
a controller configured to extract information about wine contained in the wine bottle based on the image of the label captured by the image sensor;
a dispensing head provided on the cabinet and configured to dispense wine contained in the wine bottle, a contact space in which the wine is in contact with outside air being defined inside the dispensing head; and
an aerator provided in the dispensing head and having at least one discharge hole through which the wine is discharged to the contact space, the controller being further configured to adjust at least any one of a size of the at least discharge hole, a length of the at least e discharge hole, a number of the at least one discharge hole through which the wine is discharged, or an output direction of the e from the at least one discharge hole.

2. The wine storage device of claim 1, further comprising a door coupled to the cabinet acid configured to open and close the storage space,
wherein the image sensor is positioned on an inner surface of the door facing the storage space.

3. The wine storage device of claim 2, wherein:
as the image sensor rotates with the door, an angle of view of the image sensor toward the storage space changes, and
the wine storage device further comprises splay device that presents an indication of whether the controller is able to extract the information about the wine based on the image of the label captured by the image sensor at the angle of view.

4. The wine storage device of claim 1, further comprising:
an actuator provided in the cabinet and configured to raise and lower the wine bottle,
wherein the controller is further configured to manage the actuator based on a user input.

5. The wine storage device of claim 1, wherein:
the dispensing bead includes a main dispensing pipe,
when the aerator is deactivated, the wine is dispensed through only the main dispensing pipe of the dispensing head and without passing through the discharge hole, and
when the aerator is activated, the wine is dispensed either through only the discharge hole or through both with the main dispensing pipe and the discharge hole.

6. The wine storage device of claim 1,
wherein the aerator comprises:
an opening and closing wall configured to move up and down in the contact space; and
a discharge body received in the opening and closing wall and having a plurality of the discharge holes, and
wherein when the opening and closing wall moves up or down, at least a subset of the discharge holes is exposed, and the wine is discharged through the exposed subset of the discharge holes.

7. The wine storage device of claim 6, wherein the aerator includes a main dispensing pipe connected to the wine bottle,
the opening and closing wall is moved up and down along the main dispensing pipe, and
the discharge holes are formed in an outer circumferential surface of the discharge body.

8. The wine storage device of claim 1,
wherein the aerator comprises a rotary dispensing pipe provided rotatably inside the contact space, the discharge hole being formed in along a section of the rotary dispensing pipe extending along a longitudinal direction, and
wherein when the rotary dispensing pipe is rotated to a particular position, the discharge hole is open toward a wine discharge hole of the dispensing head, and when the rotary dispensing pipe is rotated away from the particular position, a position of the discharge hole does not correspond to a position of the wine discharge hole, and the discharge hole is open toward an inner surface of the contact space.

9. The wine storage device of claim 8, wherein:
the contact space has a disk shape or a spherical shape, and
a length of the rotary dispensing pipe is less than an inner diameter of the contact space, and opposite ends of the rotary dispensing pipe are spaced apart from the inner surface of the contact space.

10. The wine storage device of claim 1, wherein the aerator comprises:
a first dispensing pipe fixed in the contact space; and
a second dispensing pipe connected to the first dispensing pipe, the second dispensing pipe at least one of overlapping with the first dispensing pipe or extending in a direction away from the first dispensing pipe.

11. The wine storage device of claim 1, further comprising
a communication interface,
wherein the communication interface exchanges information with an external server, and exchanges information with a user terminal wirelessly connected to the communication interface.

12. The wine storage device of claim 1, further comprising a spectral sensor provided in the cabinet, wherein the spectral sensor measures spectral attributes of light from the wine and provides information about the light to the controller.

13. The wine storage device of claim 12, wherein the spectral sensor is provided at at least one of a transparent dispensing pipe through which the wine is dispensed or a transparent measuring tank in which a portion of the wine is temporarily stored, the spectral sensor part being configured to measure the spectral attributes of the light from the wine present in the at least one of the transparent dispensing pipe or the transparent measuring tank.

14. The wine storage device of claim 1, further comprising a gas tank configured to store an inert gas that is delivered into the wine bottle to prevent oxidation of the wine within the some bottle.

15. The wine storage device of claim 1, further comprising:
a cooling device provided in the cabinet and configured to adjust a temperature of the storage space, and
a support on which a bottom surface of the wine bottle is seated and provided at a bottom of the storage space, the support being configured to be at least one of moved vertically or rotated, and a height of the label being adjusted based on the support being moved vertically and an angle at which the label is directed being adjusted based on the support being rotated.

16. A method of dispensing wine using a wine storage device, the method comprising:
obtaining, by an image sensor, an image of a label of a wine bottle received in a cabinet of the wine storage device;
extracting, by a controller, at least one of characters or symbols from the image of the label;
obtaining, by the controller, information about the wine based on the extracted at least one of the characters or the symbols;
supplying the wine contained in the wine bottle to a dispensing head; and
aerating the wine dispensed by an aerator in the dispensing head and adjusting an intensity of the aerating based on the information about the wine.

17. The method of claim 16, further comprising:
receiving and storing a user input, wherein the aerating intensity is adjusted further based on the user input.

18. The method of claim 16, further comprising:
detecting, by a spectral sensor, attributes of light from the wine;
determining, by the controller and based on the attributes of light detected the spectral sensor, at least one of a sugar content, an acidity level, an alcohol concentration, or a tannin concentration of the wine.

19. The method of claim 16, further comprising:
adjusting at least one of a temperature or an acidity of the wine according to the information about the wine when the wine is dispensed through the dispensing head.

20. The method of claim 16, further comprising:
outputting information related to an extraction failure through a display device provided in the cabinet when the controller is unable to extract the at least one of the characters or the symbols from the image of the label, and
wherein obtaining the information about the wine based on the extracted at least one of the characters or the symbols includes:
comparing the extracted at least one of the characters or the symbols with information stored in a memory of the wine storage device and obtaining the information about the wine from the memo when the extracted at least one of the characters or ti symbols corresponds to the information stored in the memory; and
when the extracted at least one of the characters or the symbols does not correspond to the information stored in the memory, supplementing the information stored in the memory with additional information about the wine that is at least one of received from an external device or input by a user.
